(19) United States
(12) Patent Application Publication
(10) Pub. No.: US 2004/0256803 A1
(43) Pub. Date: Dec. 23, 2004

(54) Method and device for providing an improved tie wager for the game of Baccarat

(76) Inventor: Shenli Ko, Las Vegas, NV (US)

Correspondence Address: Anderson & Morishita, L.L.C., Suite 102, 2725 S. Jones Blvd., Las Vegas, NV, 89146, US

(21) Appl. No.: 10/690,178

(22) Filed: Oct. 20, 2003

Related U.S. Application Data
(60) Provisional application No. 60/454,123, filed on Mar. 11, 2003.

(51) Int. Cl. A63F 1/00; A63F 13/00

(52) U.S. Cl. 273/292; 463/11

(57) ABSTRACT

A method and device are set forth for providing a new tie wager which includes issuing an award where there is a tie between the Banker and Player hands, a near miss condition and where, for certain ties an enhanced award can be issued to the player.

### CROSS-REFERENCE TO RELATED APPLICATIONS

The present application is a conversion application of prior filed provisional application Ser. No. 60/454,123 filed Mar. 11, 2003 and titled A Baccarat Tie Wager.

### FIELD OF THE INVENTION

The present invention relates to methods and devices for playing Baccarat and Baccarat games of the type offering a tie wager. More particularly it relates to a method and device for providing an improved tie wager.

### BACKGROUND

In casinos a popular card game of chance is Baccarat. In Baccarat there are two surrogate players who oppose each other, the Player and the Banker. The casino (or house) takes the opposite position of each wager. With up to 12 playing positions at a table, a bettor may place his or her wager in one of two manners: with the Banker or with the Player. The player's objective is to select the surrogate hand that will have a card value total, according to the rules, that is closer to 9 than the opposing hand. In Baccarat the player may also place a wager that the hands will have a tie value total.

After the placing of wagers with the Banker or Player, two initial cards are dealt to each of the surrogates, Player and Banker. The game is played modulo ten, that is, if the total value sum of a hand equals or exceeds 10, then 10 is subtracted from the total, i.e., only the last digit is used as the value of the hand. Hands will always have a value of between 0 and 9. Aces have a value of 1, 10's and face cards a value of 0, and all other cards have their face value.

If the Player's (or Banker's) initial two card values have a sum or value of 8 or 9, the cards of the hands are turned over immediately. A 9 wins over any lesser total. If neither the Player nor Banker has a 9, then 8 wins over any lesser total. Ties are pushes.

If neither the Banker nor the Player hand initial cards have a count of 8 or 9 (requiring immediate exposure of the hands), then the Player hand has the next play and must stand or be dealt a third card according to the following table:

PLAYER RULES

| Initial Count | |
|---|---|
| (Sum of Values of Initial Cards) | Action |
| 0-5 | Draws a card |
| 6-7 | Stands |

The value of the third card, if drawn, is added to the values of the initial two cards, modulo ten, to arrive at the Player hand final count. If no third card is drawn, the initial count becomes the Player hand final count.

Then it is the Banker's turn. The Banker's action is determined by: (1) his initial 2-card hand value and (2) the value of the third card, if any, dealt to the Player hand. The Banker's action follows these rules.

| | | Does Not Draw |
|---|---|---|
| Initial Count | Draws if Value of | if Value of Third |
| (Sum of Values | Third Card Dealt to | Card Dealt to |
| of initial cards) | Is Player Is | Player is |
| 3 | 0-7, 9, or no card | 8 |
| 4 | 2-7, or no card | 0, 1, 8-9 |
| 5 | 4-7, or no card | 0-3, 8-9 |
| 6 | 6-7 | 0-5, 8-9, or no card |
| 7 | stands | stands |
| 8-9 | turns over | turns over |
| 0-2 | draws a card | draws a card |

The foregoing rules are based on the odds of bettering the Banker initial hand count relative to the Player hand final count. They are fixed rules. If a third card is drawn, its value is added to the values of the initial cards, modulo ten, to arrive at the Banker hand final count. If no third card is drawn, the Banker's initial count becomes the Banker's final count.

Once play is completed by the Banker, the final hands are resolved with the hand with the final count closest to 9 deemed the winner. Wagers are then paid even money to all those who wagered with the victorious Banker or Player. Wagers with the loser are collected. Ties are a push and no one wins or loses. Since the odds favor the Banker hand, a 5% commission is collected by the casino on winning bets placed with the Banker hand. Tie wagers are typically paid at 8:1 where such wagers are made and the Banker and Player hands tie.

In Baccarat, there are no choices. When cards are drawn or when the Player or Banker stands are determined by the tables set forth above. Further, all those wagering with the Player (or Banker) are bound by the play and luck of their surrogate.

Chemin de Fer, differs from Baccarat in that players occupy both positions of Banker and Player with the house taxing the winnings of the player acting as Banker. The Banker position rotates, or can be usurped with the “Banco” wager.

Continental Baccarat (played in France), gives the Player an option of drawing or standing only on an initial count of 5. The Banker's draw is entirely optional.

Other Baccarat type games have been proposed, as will be discussed below.

U.S. Pat. No. 5,395,119 issued to Jacob et al discloses additional optional bets for the game of Baccarat, in which the player, who is given the option to surrender his main wager, may place a “super tie” bet on Player and Banker hands of identical count which each have a predetermined value, or a “jackpot tie” bet on every card in the two hands to be of the same value. The super tie bet requires the player to specify a specific numeric value for the sum of the respective values of the cards of the tied player and banker hand. A player of the jackpot tie bet may bet upon the occurrence of four or six of a specific value card (e.g., 8-8 vs. 8-8 and 2-2-2 vs. 2-2-2), the occurrence of any four or six of a kind, or the occurrence of all face cards in the two hands.

U.S. Pat. Nos. 6,164,651 and 6,328,306 issued to Webb disclose multiple betting options for the game of Baccarat or the like. The optional proposition bets include a “win by” bet that the side (Banker or Player) chosen by the player will win the game by a particular amount and a “tie with” bet that the two sides will tie with a particular amount.

U.S. Pat. Nos. 6,241,250 and 6,488,284 issued to Webb disclose a Baccarat variation that includes a proposition wager that a first side and a second side will tie. The tie wager is resolved differently according to whether the equal first and second side numerical result falls into a first group of numerical results or a second group of numerical results. In one embodiment the tie wager is paid 8 to 1 when the numerical total is an even number and 9 to 1 when the numerical total is an odd number. Zero is considered an even number.

U.S. Pat. No. 6,237,917 issued to Timpano discloses a variation of conventional Baccarat, in which each player and the dealer will receive their own hand and the player has the option to draw a card at their own discretion. The player has the option to make a tie bet that their hand and the dealer hand will tie, just as in conventional Baccarat.

U.S. patent application No. 20010035609 by Vancura discloses a method of playing and wagering on a game of chance with a number of preselected community events that incorporate a variation of the conventional Baccarat tie bet. Like U.S. Pat. No. 5,395,119, specific combinations of cards in tied hands are selected and paid at different odds.

It has also been known to provide for play of Baccarat on electronic devices such as computers, PDA, electronic slot machines and hand held novelty devices.

In regards to a tie bet, such wagers, to be won, require that the Banker and Player hands tie, e.g., have same numerical value. In conventional Baccarat the probability of a tie is only 9.52%, or one in 10.5 hands, so most of the time the player will lose their tie wager. Sometimes the losing streak can last so long that the player gets frustrated. Also, the low 8 to 1 payoff is unattractive.

The present invention overcomes the drawbacks with the conventional Baccarat tie wager and the tie wagers as disclosed in the above prior art by increasing the winning frequency and providing bigger and proportionally distributed awards. The winning frequency is increased from 9.5% to 26.2% by including near miss” hands which are within 1 of each other. As a result, it not only alleviates the player's frustration with a losing streak, but also turns a disappointment (the near miss) into a pleasant surprise. Also, bigger awards are paid when some preselected tie hands are dealt, which creates excitement. Moreover, instead of the inflexible “one-size-fits-all” 8 to 1 award, the awards of the invention are proportionally distributed based on the frequency of occurrence of each winning hand combination, which allows for more flexibility in adjusting the house advantage to meet individual casinos' needs. Moreover, the invention does not require the bettor to select any specific tying value, or which side will win by a specific amount. The bettor will not be disappointed when the specific tying value does not come up, the chosen side does not win by the specific amount, or the side not chosen wins. Also, no additional bets need to be created; there remains the tie bet that the Baccarat players are familiar with. Additional bets not only confuse the players but also clutter the table layout and make it look intimidating.

There is a need for an improved tie wager in Baccarat and Baccarat type games which has a higher winning frequency and which can provide higher awards to the player making the wager more attractive and exciting, to the players and also providing for more revenue to the casino.

### SUMMARY OF THE INVENTION

There is set forth, according to the present invention, a method and device which provides for an improved tie wager for Baccarat—type games. By Baccarat—type games what is meant is games such as conventional Baccarat (in its various forms), Chemin de Fer, and other games which feature competing, surrogate hands (like the Banker and Player hands) upon which the game players wager. The method can also be applied to other games wherein a tie wager is or can be offered, such as Casino War and Blackjack.

The method and device, in one aspect of the present invention, includes a player placing a tie wager and the game is dealt according to its rules to produce outcome values for the surrogate hands. The player wins their tie wager in the event at least one of the following, preselected, conditions occurs;

(1) the Banker and Player hands tie or are within at least one of each other,

(2) the Banker and Player hands tie and a predetermined, aggregate, number of cards have been dealt to both hands in that round of play, and/or

(3) the Banker and Player hands tie and (a) a predetermined, aggregate, number of cards have been dealt to both hands in that round and (b) the tie is at a predetermined value.

In one aspect, and unlike conventional Baccarat, the player can win their tie bet not only when the hands tie, but also when the hands are within a small, predetermined value, e.g., within 1 of each other, hence a “near miss.”

In another embodiment the near miss feature may or may not be included and when the hands tie, the player is issued an award which varies with the value at which the hands tie and/or with a predetermined, aggregate number of cards which have been dealt to the surrogate hands. An example is given in the following pay table:

| Tie Result | Award |
|---|---|
| 5 card tie at 3 | 50:1 |
| 6 card tie at 7 thru 9 | 9:1 |
| Hands tie at 0 thru 3 | 7:1 |
| Hands tie at 4 or 5 | 6:1 |
| Hands Tie at 6 thru 9 | 3:1 |
| Hands within 1 of each other | 1:1 |

By providing the method and device having the improved tie wager, players of the game are more likely to make the tie wager, tie conditions with the near miss feature will occur more frequently enticing players to make the bet and the offer of large returns on the wager provide a further inducement to the players. From the standpoint of the casino, revenues will increase inasmuch as more tie wagers will be made and thus the casino would expect to see greater profits.

### BRIEF DESCRIPTION OF THE DRAWINGS

These and other features and advantages will become appreciated as the same becomes better understood with reference to the specification, claims and drawings wherein:

FIG. 1 is a diagram for a device for the play of a game according to the present invention; and

FIG. 2 is a logic diagram for a device to provide for play of the improved tie wager.

### DESCRIPTION

The present invention is directed to a method and device which provides for an improved tie wager for Baccarat—type games. By Baccarat—type games what is meant is games such as conventional Baccarat (in its various forms), Chemin de Fer, and other games which feature competing, surrogate hands (like the Banker and Player hands) upon which the game players wager.

To play the game of the present invention, according to one embodiment, the player makes a tie wager. The tie wager may be the sole wager made by the player or the player may wager on one of the Banker and Player hands, as is well known in Baccarat games. The game may be hosted at a gaming table providing for seating of multiple players, such as from 7 to 12 players.

Cards are then dealt according to the rules of play for the surrogate Banker and Player hands according to the established rules of play set forth above. The hands may be dealt from a shoe containing multiple decks, e.g., 6 or more decks, as is also well known in the art.

The present invention is directed to the tie wager and the resolution of any Banker/Player wager is according to the established rules of the game, which are well known and will not be discussed herein.

According to the embodiment of the present invention, the tie wager is resolved according to the following rules. A tie, as is known in the art, refers to a condition where both surrogate hands have a final outcome value or sum total, according to the rules of the game, which is the same. For example, a tie may be when the Banker and Player hands have the same, final outcome, value or sum of 6.

The tie wager according to this embodiment of the present invention can be resolved according to the following schedule:

| Tie Result | Award (X tie wager) |
|---|---|
| Banker and Player hands tie | 5 to 1 |
| Within 1 of each other (near miss) | 1 to 1 |

Thus according to this embodiment, and contrary to the practice of conventional Baccarat, the player wins their tie bet not only when the hands tie but also when they are within 1 of each other, e.g., a near miss condition. For example, if the Banker hand is 6 and the Player hand is 7, the tie bettor would win the tie wager and be awarded even money on his tie wager based upon the near miss condition. The same result would occur where the Player hand is 5 and the Banker hand is 4.

The near miss condition applies where the Banker and Player hands do not tie exactly but are within a predetermined sum or final value of each other. It should be understood that the near miss condition may be limited to a near miss of 1 or it may be applied to a near miss of 2 or any other number or combination of numbers. The preferred embodiment is to use a near miss of 1 along with the tie for issuing an award for the tie wager.

In another embodiment, the near miss feature may be coupled with a pay table providing higher pays for ties at certain numbers or values. For example, the pay table for the tie bet may be as follows:

| Result | Award |
|---|---|
| Tie at 1 | 25:1 |
| Tie at 2 | 12:1 |
| Other ties | 4:1 |
| Near Miss | 1:1 |

Other pay schedules and tie result values may be used as well.

In another embodiment, which may be used with the near miss feature, the player is issued a different award based upon the number of cards dealt to the Banker and Player hands. In one variation of this embodiment, an award is provided based on the aggregate number of cards dealt to the Banker and Player hands per round. For example, an award schedule without the near miss feature as set forth below may be adopted:

| Tie Condition | Award |
|---|---|
| 5 Card Tie | 10:1 |
| 6 Card Tie | 9:1 |
| 4 Card Tie | 8:1 |

Thus if the player made a tie wager and a total of five cards were dealt to the Banker and Player hands which tie, e.g., 10-4-2 vs. A-5 (five total cards dealt), the player would be paid ten times their tie wager.

In yet another embodiment, the player is issued an enhanced award based upon the tying value or sum such as according to the following schedule;

| Tying Sum | Award |
|---|---|
| 4-5 | 15:1 |
| 0-3 | 10:1 |
| 6-9 | 7:1 |

In still a further embodiment, the features above (requiring an exact tie and/or an aggregate number of dealt cards required, or including the tie “near miss” feature) may be combined to produce award schedules for the tie wager as follows:

| Tie Condition | Award |
|---|---|
| *5 card Tie at sum of 3 | 50:1 |
| 6 Card Tie at sums of 7 thru 9 | 10:1 |
| Ties at sums of 0 thru 3 | 8:1 |
| Ties at sums of 4 or 5 | 7:1 |
| Other Ties at sums of 6 thru 9 | 6:1 |
| *A 5-card tie at 3 will be 2-3-8 vs. 6-7 | |
| 5 card Tie at sum of 3 | 30:1 |
| 6 Card Tie at sums of 4 thru 9 | 12:1 |
| Other Ties | 8:1 |

If the near miss feature were added to any of the foregoing schedules, there would be provided a 1:1 award for a near tie where the hands differ by 1 or the other, designated, near miss difference, while the awards for the other tie conditions would be reduced. An example is given below:

| Tie Condition | Award |
|---|---|
| 5 card Tie at sum at 3 | 30:1 |
| 6 Card Tie at sums at 4 thru 9 | 11:1 |
| Other Ties | 4:1 |
| Within 1 of each other | 1:1 |

The method of the present invention can be embodied into an electronic novelty device, computer game or casino game which provides for the play of the base Baccarat—type game as well as the tie wager as hereinafter described.

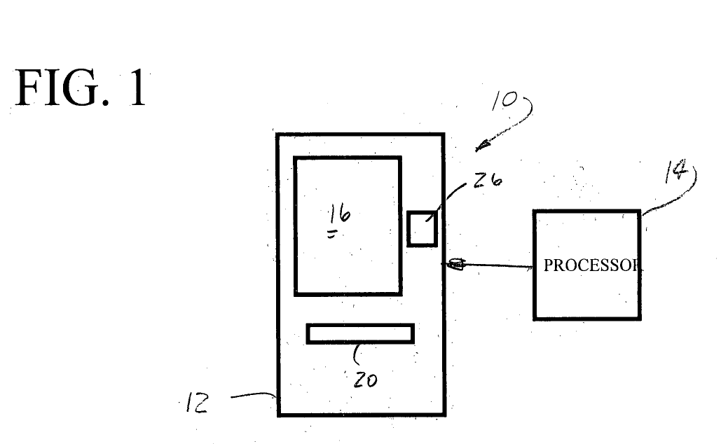

Turning to FIG. 1 there is shown an embodiment of a gaming device 10 according to the present invention. The device 10 is embodied as a gaming machine of the type having a cabinet 12 housing a processor 14 of the type known in the art. Mounted on the cabinet 12 is a display 16 controlled by the processor 14 and which is an electronic display such as a plasma display, VRT, monitor or the like as is known in the art. In the embodiment of FIG. 1 the display 16 is controlled to display the features of a base game and a bonus game according to the present invention.

Not shown in FIG. 1 are wagering means, as is known in the art, such as one or more of a token/coin acceptor, cash validator and acceptor, credit/debit card reader or other suitable means for a player to make wagers to play the game.

While the following description is directed to a casino gaming apparatus where monetary units or their equivalent, such as accumulated gaming credits, are wagered and won, it should be understood that the method can be practiced as a novelty game where fictitious gaming credits are wagered and won such as a computer game, PDA game or other novelty game format.

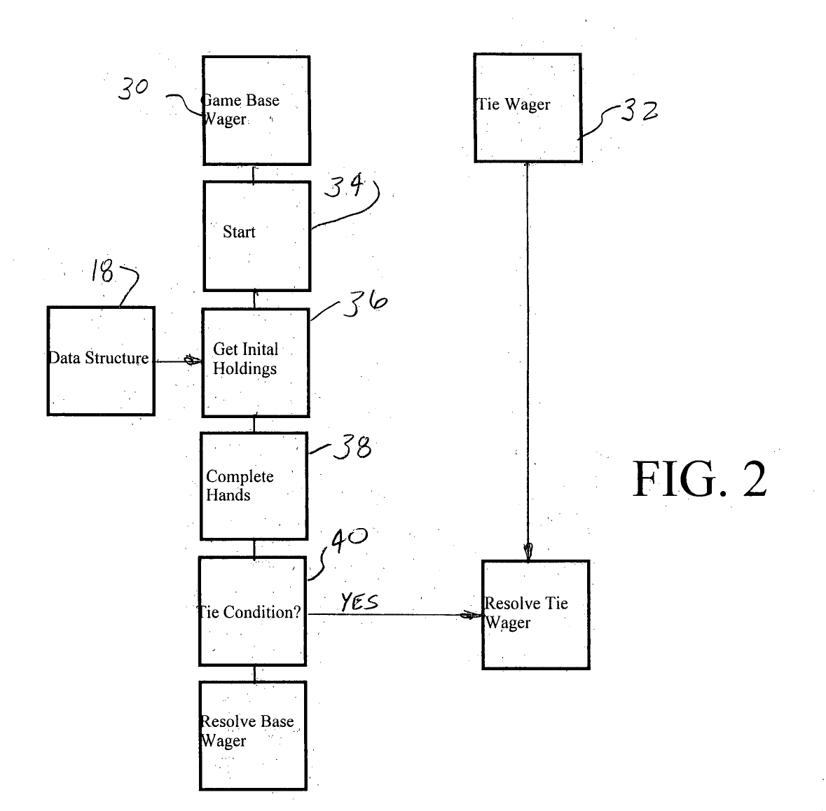

The controlling computer processor 14 includes a random number generator (not shown) and digital data storage device shown as a data structure 18 (FIG. 2). In an alternative embodiment the display 16 may be operated by and communicate with a remotely located processor 14, such as at a remote server. Preferably, the display 16 is embodied as a touch screen display which also provides means for the player to control the play of the game. Alternatively, the play control means may be any suitable data input means such as game control buttons 20 (shown as a group), keyboard, mouse or the like. For purposes of the following description, these data input means will be referred to as a touch screen display 16.

The device 10 also includes a pay out apparatus (not shown) which may be embodied, as is known in the art, as a hopper device to receive coins/tokens and dispense the same, means for accumulating game play credits, apparatus for writing to a credit voucher, credit card crediting device or the like.

As is known in the art, the device 10 may also include a card reader 26 to read a player loyalty card and identify the player to a player tracking system processor (not shown).

Turning to FIG. 2 the operation of the device 10 will now be described. At 30 the player makes their base game wager as by entering a wager on one of the Banker or Player hands as is known in Baccarat—type games. At 32 the player enters their tie wager according to the present invention. After entering the wager at 34 the play of the hand is begun as by the player touching a play button or suitable indicator on the touch screen display 16. At 36 the processor 16 is controlled to select the initial two cards for each of the Player and Banker hands from data representing, for example, six decks of standard playing cards and displays the same at the display 16. Based upon pre-programmed rules of play, at 38 the processor is configured to complete the hands to final outcome holding and values, also according to the rules of the game. For example the processor 14 may be programmed with the draw rules of conventional Baccarat as disclosed above. After the hands are completed the processor 14 is configured to determine the hand final values or sums and at 40 determines if a tie condition exists. As stated above, a tie condition, under various embodiments of the present invention may occur with a precise tie in final sums or in a near miss condition as herein described. At 40 the base wager is resolved. It should be noted that where the near miss feature is provided, where the hands differ by the near miss amount, e.g. 1, one of the Banker or Player hands will also be declared the winner.

If a tie condition is determined by the processor 16, the tie wager is resolved according to one or more of the award schedules set forth herein.

The method of the present invention can also be practiced over the Internet either by providing for the remote play of a live game by players at their remote terminals or by providing for electronic play of a virtual game.

While I have shown and described certain embodiments of the present invention, it should be understood that it is subject to many modifications and changes without departing from the spirit and scope of the claims set forth herein.

I claim;

1. An improved method for providing a tie wager in a Baccarat type card game where there are two competing Banker and Player hands, the method comprising:
a player placing a tie wager;
issuing an award to the player for the tie wager in the event of at least one of
(1) the Banker and Player hands tying or being within at least one of each other,
(2) the Banker and Player hands tying and a predetermined number of cards having been dealt to the -hands in that round, and
(3) the Banker and Player hands tying and (a) a predetermined number of cards having been dealt to the hands in that round and (b) the tie being at a predetermined value.

2. An Improved method for providing a tie wager in a Baccarat type game where there are two competing Banker and Player hands, the method comprising:
a player making a tie wager; and
issuing an award to the player based on the tie wager when one of (a) the Banker and Player hands tie in value or (b) the Banker and Player hands are within at least 1 of each other.

3. The method of claim 2 comprising issuing an award to the player if the hands tie or are within 1 of each other.

4. The method of claim 3 comprising issuing an award to the player based upon their tie wager according to (1) if a tie 5:1 and (2) if within 1 of each other 1:1.

5. The method of claim 2 comprising issuing an award to the player where the Banker and Player hands tie based upon the total number of cards dealt to the Banker and Player hands combined in that round of play.

6. The method of claim 5 comprising issuing an award to the player based upon the tie wager according to the schedule of:

| Total number of cards dealt | Award |
|---|---|
| 5 | 6:1 |
| 6 | 5:1 |
| 4 | 4:1 |

7. The method of claim 2 comprising issuing an award to the player where the Banker and Player hands tie based upon the tie values.

8. The method of claim 7 comprising issuing an award to the player based upon the tie wager where the Banker and Player hands tie according to the schedule of:

| Tie Value | Award |
|---|---|
| 4 thru 5 | 12:1 |
| 0 thru 3 | 7:1 |
| 6 thru 9 | 3:1 |

9. The method of claim 2 comprising issuing an award to the player based upon the tie wager when the Banker and Player hands tie and upon both the tie value and the number of cards dealt to the Banker and Player hands combined.

10. The method of claim 9 comprising issuing an award to the player based upon the tie wager when the Banker and Player hands tie according to the schedule of

| Tie Outcome | Award |
|---|---|
| 5 card Tie at sum of 3 | 30 |
| 6 Card Tie at sums of 4 thru 9 | 11 |
| Other Ties | 4 |

11. An improved method for providing a tie wager in a Baccarat type game where there are competing Banker and Player hands, the method comprising:
a player making a tie wager; and
issuing an award to the player when said hands tie and a predetermined number of cards have been dealt to said hands combined.

12. The method of claim 11 comprising issuing an award to the player based upon their tie wager and according to the following schedule:

| | |
|---|---|
| 5 card tie | 10:1 |
| 6 card tie | 9:1 |
| 4 card tie | 8:1 |

13. An improved method for providing a tie wager in a Baccarat type game where there are competing banker and Player hands, the method comprising:
a player making a tie wager;
issuing an award to the player based upon the value at which the hands tie.

14. The method of claim 13 comprising issuing an award to the player based upon the tie wager and the following schedule:

| Hands Tie At | Award |
|---|---|
| 4 thru 5 | 15:1 |
| 0 thru 3 | 10:1 |
| 6 thru 9 | 7:1 |

15. An improved method for providing a tie wager in a Baccarat type game where there are competing Banker and Player hands, the method comprising:
a player making a tie wager; and
issuing an award to the player when the Banker and Player hands tie according to the following schedule,

| Tie Result | Award |
|---|---|
| 5 card Tie at sum of 3 | 30 |
| 6 Card Tie at sums of 4 thru 9 | 12 |
| Other Ties | 8 |

16. A gaming device for the play of a Baccarat type game having two competing hands, the device comprising:
a computer processor;
a data structure storing data corresponding to at least one deck of playing cards;
means for a player to make a tie wager; and
said processor configured to select from said data structure and display cards for each of the competing hands according to the rules of the game, to determine a condition of when the hands have a (1) tie outcome or (2) have outcomes within at least one of each other and to issue an award to the player based upon the tie wager in the event of (1) or (2).

17. The device of claim 16 comprising said processor configured to determine a condition of when the hands have (1) a tie outcome or (2 have outcomes within one of each other and to issue an award to the player based upon the tie wager in the event of (1) or (2).

18. The device of claim 17 comprising said processor configured to issue an award of 5:1 based upon a determination of a tie outcome and an award of 1:1 based upon a determination of said hands having outcomes within one of each other.

19. An improved method for providing a tie wager in a Baccarat type card game where there are two competing Banker and Player hands, the method comprising:
a player placing a tie wager;
comparing the final hand values for the Banker and Player hands; and
(1) if the hands tie at a predetermined one or more values, issuing an award to the player at greater than 1:1 based upon the tie wager, and
(2) if the Banker and Player final hands are within at least one of each other, issuing an award to the player based upon the tie wager.
